(19) United States
(12) Patent Application Publication
(10) Pub. No.: US 2025/0209823 A1
(43) Pub. Date: Jun. 26, 2025

(54) Homography Generation for Traffic Monitoring System

(71) Applicant: Southwest Research Institute, San Antonio, CA (US)

(72) Inventors: Ryan M. McBee, San Antonio, TX (US); Jonathan K. Esquivel, San Antonio, TX (US); Daniel S. Rossiter, San Antonio, TX (US)

(21) Appl. No.: 18/394,171

(22) Filed: Dec. 22, 2023

(51) Int. Cl. G06V 20/54; G08G 1/0967; H04N 23/695

(52) U.S. Cl. CPC G06V 20/54; G08G 1/0967; H04N 23/695

(57) ABSTRACT

A method and system for generating a homography of a roadway traffic scene imaged by a traffic camera. Data is stored representing the global location of roadway(s) in the scene. Camera images of the scene are acquired. At least one vehicle in the scene is detected and tracked acquire its track path of the vehicle on a portion of the roadway. The track paths is matched to a corresponding globally located roadway. The result of the matching step is used to generate a candidate homography matrix. The tracking and matching of track paths is repeated for a number of vehicles, which may be traveling in a different direction on the roadway or on a different roadway in the scene, thereby obtaining a set of candidate homography matrices. The candidate matrices are evaluated and a best homography is selected.

### BACKGROUND OF THE INVENTION

Today's traffic management systems are designed to provide an organized and integrated approach to minimize congestion and improve safety on city streets through connected technology. Real time traffic management systems manage traffic by using a network of technologies that may include various sensors and cameras and global positioning systems (GPS). This approach to traffic management can be used to reduce congestion, prevent bottlenecks, and to solve other traffic issues.

Traffic management systems often use pan, tilt, and zoom (PTZ) capable cameras mounted on roadways to gain insights on real-time traffic status. Conventionally, these systems are observed manually.

In camera-based observation systems, for traffic control and otherwise, emerging technologies are directed to automated observation. One approach to automated observation makes use of homographies. A homography relates the pixel coordinates in two images from different viewpoints through the use of a transformation matrix. Once the matrix is generated, subsequent images of the same camera view can be transformed using the matrix.

A specific example of a homography is one that projects an image into a global perspective, such as an overhead viewpoint. The transformation matrix is generated using two sets of points, one in world coordinates and the other in image coordinates.

One naïve approach to generating a homography is a non-automated approach that manually matches user-identified points the two images. Generation of a homography is an error-prone process as key points may be difficult to find and slight differences in marking the correspondences between the two viewpoints can create extremely skewed and distorted images. A manual homography generation process requires a significant effort from a subject matter expert. Algorithms to automate the process exist but often struggle to identify corresponding features in the images due to their drastically different appearance from different viewpoints.

### BRIEF DESCRIPTION OF DRAWINGS

FIG. 1 illustrates a traffic management system that generates homographies in accordance with the invention.

FIG. 2 illustrates the process of generating homographies.

### DETAILED DESCRIPTION OF THE INVENTION

The following description is directed to automation of homography generation, with each homography relating the images captured by a video camera to real world coordinates. More specifically, the method relates a camera image to real world coordinates, by tracking vehicles detected in camera images and matching their track paths to globally located roadways in the image. Because the vehicle tracks and the roadways can be assumed to reside on the same plane, the homography estimation task is simplified. The homography then allows mapping of image coordinates to global coordinates for the entire camera image.

The homography is easily updated in response to movements of the camera, such as with a pan/tilt/zoom camera. The updating is agnostic to the type of camera and knowledge of its movements. The only information needed is that the camera has moved.

Once the image coordinates of a scene can be mapped to global coordinates, the coordinates of objects in a scene, including vehicles, are available. Distances between objects can be easily known. Other information, such as speed and direction of travel, can also be easily known.

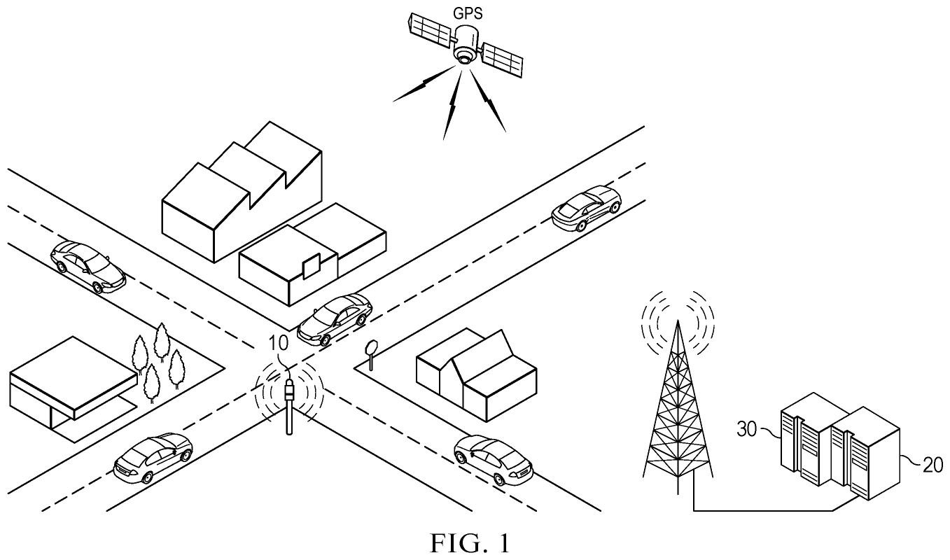

FIG. 1 illustrates a traffic management system in accordance with the invention. A video camera 10 is mounted near a roadway structure. For purpose of example herein, camera 10 is a PTZ camera, which may move and thus provide different traffic views, and thus require homography updating. However, the same concepts apply to stationary cameras or “moveable” cameras with movement other than PTZ to provide different perspectives of the roadway structure. It is assumed that camera 10 provides a series of images sufficient to track a vehicle, and a camera having this capability is referred to herein as a video camera.

The view of camera 10 is referred to herein as a “traffic scene” and contains at least one structured roadway. In the example of FIG. 1, the roadway structure is two intersecting roadways.

Camera 10 collects video of the structured roadway's environment. It is assumed that ground-based vehicles, such as cars, trucks, travel the roadway(s).

A global location system, such as GPS, has captured the traffic scene's global location coordinates, including those of the scene's roadway(s). An example of such coordinates are those in compliance with the World Geodetic System (WGS) 84. These coordinates are stored in a roadway global location database 20. In particular, database 20 provides geolocation data for at least one roadway of interest.

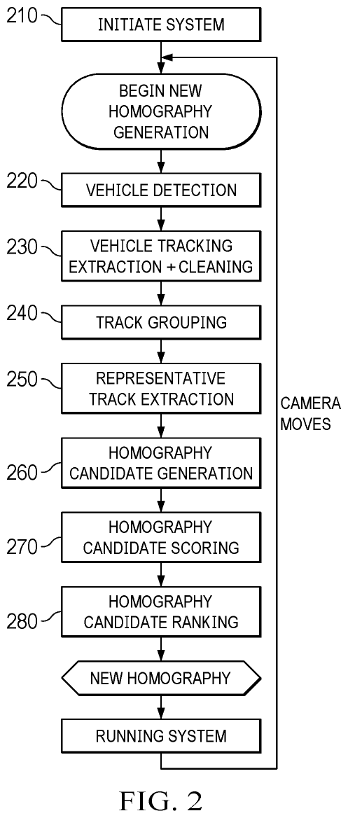

Camera 10 communicates its image data to a homography generation system 30. As explained below in connection with FIG. 2, system 30 has a tracking process that can detect and track vehicles within the camera's images. System 30 also has a homography generation process that uses the tracking information and information provided by database 20 to generate a homography of the camera scene.

Once a homography is generated, the traffic monitoring system can use global navigation system coordinates to provide accurate predictions for wrong way driver detection, vehicle speed, vehicle localization, and stalled vehicle detection. The global location database is used to approximate key points between a detected object and the known locations of the roadways to provide a conclusive mapping of ground vehicle locations to the global space.

The homography generation system 30 updates the homography each time camera 10 changes perspective. The new homography is autonomously generated. This updates to the new view of the camera and continues to predict global location, wrong way driver status, speed and perhaps additional information for all vehicles detected by the camera.

FIG. 2 illustrates the homography generation system 30 in further detail. It is assumed that system 30 is equipped with appropriate hardware and software for performing the tasks described herein.

In Step 210, homography generation is initiated by collecting data that includes at least the camera's global location, a globally located image of the traffic scene, and roadway information. The roadway information may include various information relevant to traffic monitoring, such as road names, speed limits, traffic lights, number of lanes in a roadway, and road direction(s).

In one example, initialization is achieved with a historical recording of the traffic flow. This data is mapped to a top down image of the traffic scene. This top down image is converted to global coordinates and evaluated by an operator. Subsequent images are generated automatically.

In Step 220, a vehicle tracking process uses the camera images to detect and track vehicles. It tracks vehicles for a few minutes and keeps a record for vehicles traveling across roadways of interest within the traffic scene. For each vehicle tracked, the tracking continues for a period of time sufficient to image the vehicle traveling along a distinct path for a substantial portion of a roadway depicted in the scene.

The number of vehicles tracked, their directions, and the number of roadways upon which vehicles are tracked are discretionary, but in general, the more tracking data, the more improved is the accuracy of the homography that is to be generated. Preferably, a number of vehicles are tracked, such as another vehicle on the same roadway traveling in the same direction, another vehicle on the same roadway traveling in a different direction, or additional vehicles traveling on additional roadway in the scene.

In Step 230, these detections are then transformed into track paths for each detected vehicle. The track paths are cleaned to prevent errors due to complications in the detection process such as vehicle occlusion.

In Step 240, using an unsupervised track grouping process, the track paths are grouped with respect to their locations in the camera perspective and their direction of travel.

In Step 250, representative track paths from each group are extracted.

In Step 260, the representative track paths are matched with many points sampled across the known roadways. Each track path is matched to its associated globally located roadway. Each matching provides sufficient data to generate a matrix candidate. The result of matching different track paths is a large set of candidate matrices.

In Step 270, the candidate matrices are scored by transforming each track group in the PTZ camera space to the global space. The homographies resulting from these matrices are then evaluated based on their agreement in direction, speed, and location with the known roadway. The transformation matrices themselves are also scored by evaluating the approximated field of view, camera location, and shape that is expected to come from the PTZ camera.

In Step 280, based on these scores, the homographies are ranked. The top performing homography is chosen to be the final reported homography for a particular PTZ perspective.

The selected transformation matrix is continuously fed back into the system providing traffic insights. Once the homography is generated, it can be enhanced with data from a roadway database that provides additional information such as road names, number of lanes, direction of road, and the speed limit.

Homography generation system 30 further has a camera movement detection process that detects PTZ camera 10 has changed its view. This information is communicated to the homography generation process, which repeats the above-described process to generate a new transformation matrix.

In conclusion, the homography generation system automates the process of finding accurate transformation matrices, using homographies, to transform detected vehicle objects in the camera's perspective to a universal global coordinate system. Camera movements result in a new recalculation, following the process above, and enables the transformation to the global coordinate system without the need for presets.

For each camera view, once the homography is generated, traffic management methods can be used for a variety of traffic control information. Vehicles can be GPS localized. Traffic situations such as wrong way drivers, speed limit violations and speed prediction, stalled vehicles, can all be detected.

1. A method of generating a homography of a scene imaged by a camera, the scene depicting at least one roadway, comprising:
storing data representing the global location of the roadway(s);
thereby providing at least one globally located roadway in the scene;
acquiring images of the scene, using the video camera;
detecting and tracking at least one vehicle traveling on one of the roadway(s) within the images, such that the video camera acquires a track path of the vehicle on a portion of the roadway;
matching the track path with a corresponding globally located roadway;
using the result of the matching step to generate a candidate homography matrix;
repeating the tracking and matching steps for at least one additional vehicle traveling in a different direction on the roadway or on a different roadway in the scene, thereby obtaining a set of candidate homography matrices;
evaluating homographies resulting from each of the candidate matrices;
selecting a best homography based on the evaluating step.

2. The method of claim 1, wherein the camera is moveable to change its viewpoint, and further comprising repeating the homography generation process after the camera changes perspective.

3. The method of claim 2, wherein the camera is operable to move in a tilt movement.

4. The method of claim 2, wherein the camera is operable to move in a pan movement.

5. The method of claim 1, wherein the global location is provided by GPS (global positioning system).

6. The method of claim 1, further comprising an initialization process performed by acquiring a historical image of traffic flow on the roadway, mapping traffic paths to a top down view of the traffic scene, and converting the results of the mapping step to global coordinates.

7. The method of claim 1, further comprising adding roadway information to the homography, such as, without limitation, road names, number of roadway lanes, direction of roadway travel, and speed limits.

8. The method of claim 1, wherein the camera is positioned in a fixed location near the roadway(s).

9. A system for generating a homography of a scene imaged by a camera, the scene depicting at least one roadway, comprising:
a database operable to store data representing the global location of the roadway(s); thereby providing at least one globally located roadway in the scene;
a tracking process operable to acquire images of the scene from the camera, and to detect and track at least one vehicle traveling on one of the roadway(s) within the images, thereby obtaining a track path of the vehicle on a portion of the roadway; and
a homography generation process operable to match the track path with a corresponding globally located roadway, to use the result of the matching step to generate a candidate homography matrix, to repeat the matching steps for at least one additional vehicle traveling in a different direction on the roadway or on a different roadway in the scene, thereby obtaining a set of candidate homography matrices, to evaluate homographies resulting from each of the candidate matrices and to select a best homography based on the evaluating step.

10. The system of claim 9, further comprising a camera movement detection process that detects a camera change in perspective, and informs the homography generation process of the change in perspective.

11. The system of claim 9, wherein the homography generation process repeats after a change in perspective of the camera.
